(19) United States
(12) Patent Application Publication
(10) Pub. No.: US 2006/0166072 A1
(43) Pub. Date: Jul. 27, 2006

(54) Fuel cell system, fuel cell operation method, and gas treatment device

(76) Inventors: Eiji Akiyama, Tokyo (JP); Takashi Manako, Tokyo (JP); Hidekazu Kimura, Tokyo (JP); Tsutomu Yoshitake, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/563,908

(22) PCT Filed: Jul. 9, 2004
(86) PCT No.: PCT/JP04/09819

§ 371 Date: Feb. 10, 2006

(30) Foreign Application Priority Data
Jul. 14, 2003 (JP) 2003274025

(51) Int. Cl. H01M 8/04; H01M 8/10; B01J 8/02

(52) U.S. Cl. 429/34; 429/30; 429/13; 422/211

(57) ABSTRACT

A fuel cell system (800), including a plurality of unit cells (101), a container (801) having an inlet (809) introducing the gases such as carbon dioxide generated in the electrode reaction by these unit cells (101) and an exhaust vent (807) discharging the gases, and a catalyst layer (805) placed in the container (801) that oxidizes the gases introduced in the container (801), wherein the treated gas (806) after oxidation by the catalyst layer (805) is discharged through the exhaust vent (807) of the container (801).

### TECHNICAL FIELD

The present invention relates to a fuel cell system, a method of operating a fuel cell, and a gas treatment apparatus.

### BACKGROUND ART

A fuel cell, which consists of a pair of fuel electrode and oxidant electrode, and an electrolyte placed between them, generates electricity in the electrochemical reaction occurring when a fuel is supplied to the fuel electrode and an oxidant to the oxidant electrode. Generally, hydrogen is used as the fuel, but recently, a direct type fuel cell, which directly uses methanol, a fuel cheaper and easier in handling, as the fuel, is eagerly studied recently.

When hydrogen is used as the fuel, the reaction on the fuel electrode is represented by the following Formula (1):
3H₂→6H⁺+6e⁻ (1)

When methanol is used as the fuel, the reaction on the fuel electrode is represented by the following Formula (2):
CH₃OH+H₂O→6H⁺+CO₂+6e⁻ (2)

In either case, the reaction on the oxidant electrode is represented by the following Formula (3):
3/2O₂+6H⁺+6e⁻→3H₂O (3)

In particular, direct type fuel cells, which can produce protons from an aqueous methanol solution, do not demand a reformer or the like, and are thus advantageous in miniaturization and commercialization of the fuel cells. In addition, the fuel cells are characteristic in that the energy density is very high, because a liquid aqueous methanol solution is used as the fuel.

In such a direct type fuel cell, carbon dioxide is generated in the electrochemical reaction on the fuel electrode, as shown in Formula (2). Thus, conventional fuel cells are designed to remove the carbon dioxide from the fuel electrode.

Patent Document 1 discloses a fuel cell having a reaction-product outlet port for discharging the reaction products generated in the electrochemical reaction of the fuel cell and a container connected to the reaction-product outlet port for storing the reaction products that contains a reaction product-storing chamber. It also discloses the cases when an adsorbent such as activated carbon or zeolite for adsorption of the unreacted fuel and by-products in the electrochemical reaction i.e., hazardous substances such as formaldehyde and formic acid, and a noble metal catalyst such as silver, an inorganic catalyst, or a microbial catalyst for decomposition of these hazardous substances in the container are used alone or in combination as needed. In this manner, it is possible to solve the problems in disposal of the container or in recycling, even when these hazardous substances are recovered in the container.

Alternatively, Patent Document 2 discloses a power supply system having an adsorbent material encapsulated in a by-product recovery bag that absorbs and adsorbs to immobilize, then fixes the by-products encapsulated therein. The system also has a unit of detecting the remaining encapsulation capacity of the recovery bag for notifying the time for exchanging the recovery bag and a unit of displaying the remaining encapsulation capacity.
[Patent Document 1] Japanese Laid-Open patent publication NO. 2003-132931
[Patent Document 2] Japanese Laid-Open patent publication NO. 2003-36879

### DISCLOSURE OF THE INVENTION

However, in the conventional fuel cells, the unreacted fuel and the by-products discharged from the fuel cell were collected in the container, and the container after the collection is processed as it is separated from the fuel cell, and thus, such a system had a problem that the container after the collection demands tedious processing for waste disposal or recycling. Such a fuel cell system also demands a unit displaying the remaining encapsulation capacity, as an indicator of the amounts of the unreacted fuel and by-products collected in the container and the time for replacing the container with a new container, leading to the problems such as complication of the operation and a complex structure of the fuel cell and thus difficulty in miniaturizing the fuel cell.

An object of the present invention, which is made under the circumstances, is to provide a technique of detoxifying and removing the unreacted fuel and the by-products discharged from the fuel cell in a fuel cell system having a simpler configuration and thus improving the maintainability and reliability of the fuel cell system.

According to the present invention, there is provided a fuel cell system, comprising a fuel cell including a solid polymer electrolyte membrane and a fuel electrode and an oxidant electrode placed on the solid polymer electrolyte membrane, a container storing a fuel placed in contact with the fuel electrode, an outlet passage for discharging the gas contained in the container into the air, and a catalyst placed in the outlet passage for oxidizing the gas.

The gas, which is contained in the container, includes the unreacted fuel gas and the by-products generated in the electrochemical reaction of the fuel cell. The by-products include, for example, formic acid, methyl formate, formaldehyde, and the like.

According to the present invention, it is possible to detoxify the gas discharged from the fuel cell by catalytic oxidation and discharge the detoxified gas into the air, even when the gas discharged from the fuel cell contains hazardous components harmful to the environment and the human body. Thus, it is possible to use the fuel cell system safely without adverse effects on the environment and the human body. It is also possible to prevent deterioration and malfunction of the fuel cell by the hazardous components and improve the maintainability and reliability of the fuel cell system. The fuel cell system according to the present invention may be composed in a simple configuration, for example, simply having a catalyst placed in the gas vent passage of an existing fuel cell system.

For example of the catalysts may include metals, alloys, or the oxides thereof containing at least one element selected from Pt, Ti, Cr, Fe, Co, Ni, Cu, Zn, Nb, Mo, Ru, Pd, Ag, In, Sn, Sb, W, Au, Pb, and Bi.

The fuel cell system according to the present invention may further include an oxidation-accelerating unit accelerating oxidation of the gas by the catalyst. The oxidation-accelerating unit may have an oxygen-supplying unit supplying oxygen to the gas. The oxidation-accelerating unit may also have a heating unit heating the gas or the catalyst.

In such a configuration, it is possible to oxidize the gas introduced from the container into the exhaust gas passage more efficiently and reliably. In addition, it is possible to completely oxidize and remove the components efficiently and more reliably and retain its original performance, even if the components not completely oxidized by the catalyst and liquefied components deposit on the catalyst after operation of the fuel cell system for an extended period of time. Thus, it is possible to improve the maintainability and reliability of the fuel cell system additionally.

The fuel cell system according to the present invention may have a unit accelerating discharge of the gas present in the outlet passage additionally. In this manner, it is possible to oxidize and then discharge the gas present in the outlet passage into the air efficiently.

The fuel cell system according to the present invention may have multiple fuel cells, and a container may be installed in contact with the fuel electrode of each of the multiple fuel cells. In this manner, it is possible to have a configuration containing a catalyst only in one outlet passage even when the fuel system contains multiple fuel cells, and thus to simplify the configuration of the fuel cell system.

The fuel cell system according to the present invention may further have a recovering passage for recovering the fuel supplied to the fuel electrode, and the outlet passage may be configured to discharge the gas contained in the fuel passing through the recovering passage into the air. In this way, it is possible to remove the gas contained in the recovered fuel and retain high quality of the recycled fuel.

The fuel cell system according to the present invention may further have a gas-liquid separation membrane between the container and the outlet passage, and the catalyst may be configured to oxidize the gas introduced through the gas-liquid separation membrane into the outlet passage. In this manner, it is possible to prevent inflow of a liquid fuel into the outlet passage when the fuel is liquid and improve the relative recovery rate of the fuel, and to discharge only the gas into the outlet passage, oxidize the gas by catalyst, and discharge the oxidized gas into the air.

In the fuel cell system according to the present invention, the fuel cell may be a direct type fuel cell in which a liquid fuel is supplied to the fuel electrode. For example of the fuel may include organic liquid fuels such as methanol, ethanol, dimethyl ether, other alcohols, or liquid hydrocarbon such as cycloparaffin or the like.

According to the present invention, there is provided a gas treatment apparatus, detachably connected to a fuel cell system including a unit cell having a solid polymer electrolyte membrane and a pair of fuel electrode and oxidant electrode placed on the solid polymer electrolyte membrane and a container storing a fuel placed in contact with the fuel electrode, including a housing having an inlet introducing gas contained in the container and an exhaust vent discharging the gas into the air, and a catalyst placed in the housing that oxidizes the gas taken in the housing. The catalyst is placed in such a manner that the gas introduced through the inlet of the housing may be oxidized and the gas after oxidation is discharged through the exhaust vent.

In the above configuration, it is possible to detoxify the gas discharged from the fuel cell by catalytic oxidation and discharge the detoxified gas into the air, even when the gas discharged from the fuel cell contains hazardous components harmful to the environment and the human body. Thus, it is possible to use the fuel cell system safely without adverse effects on the environment and the human body. The housing inlet of the gas treatment apparatus may be detachably connected to the outlet port placed in the fuel cell for removal of the carbon dioxide generated in the electrode reaction. In such a configuration, it is possible to oxidize and detoxify the gas discharged from the fuel cell and discharge the detoxified gas into the air, simply by connecting the housing inlet of the gas treatment apparatus to the outlet port of the container of existing fuel cells.

The gas treatment apparatus according to the present invention may further have an oxidation-accelerating unit accelerating oxidation of the gas by catalyst. The oxidation-accelerating unit may have an oxygen-supplying unit supplying oxygen to the gas. The oxidation-accelerating unit may also have a heating unit heating the gas or the catalyst.

In such a configuration, it is possible to oxidize the gas introduced into the exhaust gas passage from the container more efficiently and reliably. In addition, it is possible to completely oxidize and remove the components efficiently and more reliably and retain its original performance, even if the components not completely oxidized by the catalyst and liquefied components deposit on the catalyst after operation of the fuel cell system for an extended period of time.

In addition, the gas treatment apparatus according to the present invention may be detachably placed in the recovering passage of the fuel cell for recovering the fuel supplied to the fuel electrode.

According to the present invention, there is provided a method of operating a fuel cell, comprising oxidizing the gas discharged from a fuel cell including a solid polymer electrolyte membrane, and a pair of fuel electrode and oxidant electrode placed on the solid polymer electrolyte membrane with a catalyst and then discharging the oxidized gas into the air.

In this manner, it is possible to oxidize and detoxify the gas discharged from the fuel cell and then discharge the detoxified gas into the air and prevent adverse effects on the environment and the human body, even when hazardous components are contained in the gas.

In the method of operating the fuel cell according to the present invention, the fuel cell may be a direct type fuel cell which is driven by supply of a liquid fuel to the fuel electrode, the fuel cell may further have a container storing the liquid fuel that is placed in contact with the fuel electrode, and the gas may be discharged from the fuel container. The gas discharged from the fuel container includes a liquid fuel having a raised liquid temperature such as unreacted methanol and by-products generated in the electrochemical reaction of the fuel cell.

The method of operating the fuel cell according to the present invention may further have accelerating oxidation by catalyst. The accelerating oxidation may include supplying oxygen to the gas. The accelerating oxidation may include heating the gas or the catalyst.

The present invention, which allows oxidation and detoxification of the gas discharged from the fuel cell and discharge of the detoxified gas into the air, may reduce adverse effects on the environment and the human body.

### BRIEF DESCRIPTION OF THE DRAWINGS

The objects described above, other objects, the characteristics and advantages of the invention will be more apparent with reference to the favorable embodiments described below and the following drawing associated therewith.

FIG. 1 is a schematic cross-sectional view illustrating a structure of a fuel cell system in an embodiment of the present invention.

FIG. 2 is a schematic view illustrating the gas treatment unit of the fuel cell system shown in FIG. 1.

FIG. 3 is a schematic cross-sectional view illustrating the structure of a fuel cell system in an embodiment of the present invention.

FIG. 4 is a schematic cross-sectional view illustrating the structure of a fuel cell system in an embodiment of the present invention.

FIG. 5 is a schematic cross-sectional view illustrating the structure of a fuel cell system in an embodiment of the present invention.

FIG. 6 is a schematic view illustrating the structure of a fuel cell system in an embodiment of the present invention.

FIG. 7 is a schematic view illustrating the structure of a fuel cell system in an embodiment of the present invention.

### BEST MODE FOR CARRYING OUT THE INVENTION

Hereinafter, the present invention will be described with reference to drawings. The same reference numerals were allocated to the same elements respectively in all drawings, and thus, duplicated description of the reference numerals is eliminated.

### First Embodiment

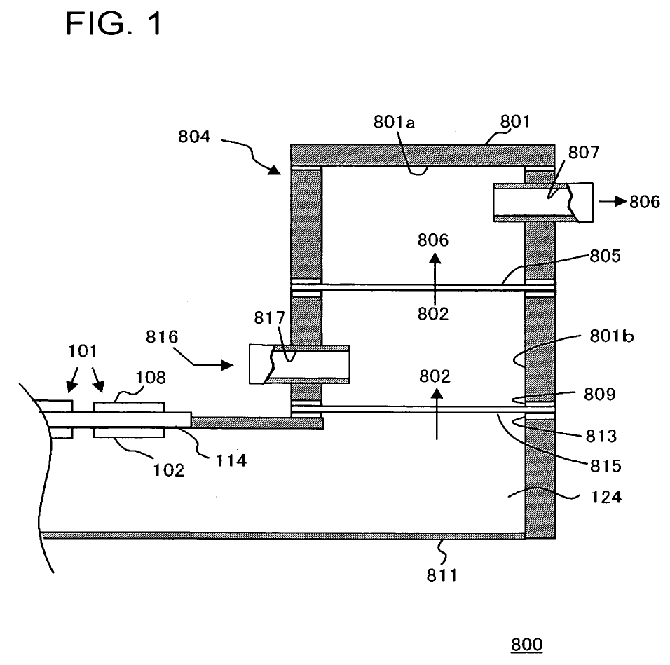

FIG. 1 is a schematic sectional view illustrating the structure of a fuel cell system in an embodiment of the present invention.

The fuel cell system 800 includes a plurality of unit cells 101 of a fuel cell and a gas treatment unit 804 treating the gas discharged from these unit cells 101.

Each of the unit cells 101 includes a fuel electrode 102 and an oxidant electrode 108 as well as a solid electrolyte membrane 114 placed between them, and a fuel 124 is supplied to the fuel electrode 102 and an oxidant to the oxidant electrode 108, generating electricity in an electrochemical reaction. The unit cell 101 is a direct type fuel cell in which a liquid fuel is supplied to the fuel electrode 102. For example of the fuel 124 may include organic liquid fuels such as methanol, ethanol, dimethyl ether, other alcohol, or liquid hydrocarbon such as cycloparaffin or the like. The organic liquid fuel may be an aqueous solution. Normally, air is used as the oxidant, but an oxygen gas may be supplied instead.

The fuel cell system 800 includes a fuel container 811 containing the fuel 124 supplied to the fuel electrode 102. The gas treatment unit 804 includes a container 801 collecting the gases 802 to be treated, including reaction products such as carbon dioxide generated in the electrochemical reaction in unit cells 101, unreacted fuel gas, and by-products, and a catalyst layer 805 placed in the container 801 that oxidizes the gases to be oxidized in the gases collected in the container 801.

In this configuration, examples of the catalysts contained in the catalyst layer 805 include metals, alloys, or the oxides thereof containing at least one element selected from Pt, Ti, Cr, Fe, Co, Ni, Cu, Zn, Nb, Mo, Ru, Pd, Ag, In, Sn, Sb, W, Au, Pb, and Bi. These catalysts are effective in oxidizing the unreacted fuel gas and by-products.

In the present embodiment, the catalyst layer 805 may have a form in which the catalyst is coated on a base member such as carbon paper. In such a case, the catalyst may be present as it is coated on at least part of the carbon paper. The catalyst may be supported on the carbon particles by a commonly used impregnation method. Examples of the carbon particles supporting the catalyst include acetylene blacks (Denka Black®, manufactured by Denki Kagaku Kogyo Kabushiki Kaisha, XC72, manufactured by Vulcan Inc., etc.), Ketjen black, carbon nanotubes, carbon nanohorns, and the like. The particle diameter of the carbon particles is, for example, 0.01 to 0.1 μm and preferably 0.02 to 0.06 μm. The catalyst layer 805 may be prepared by dispersing the catalyst-carrying carbon particles in a solvent into the form of paste and coating and drying the paste on a base member. The thickness of the catalyst layer 805 is not particularly limited, but may be, for example, 1 nm or more and 500 nm or less.

In addition to the carbon paper, a porous base member of molded carbon, sintered carbon, sintered metal, foamed metal, or the like may be used as the base member.

Alternatively, the catalyst layer 805 may have a form in which the catalyst is supported on a porous metal sheet. The porous metal sheet used may be a metal fiber sheet, and in such as case, the metal fiber sheet may be obtained by compression molding or together with compression sintering as needed of the metal fiber.

A finely roughened structure may also be formed on the surface of the metal constituting the porous metal sheet, for example, by etching such as electrochemical or chemical etching. The catalyst metal may be deposited on the porous metal sheet containing metal fibers having a roughened structure on the surface, for example, by a plating method such as electroplating or electroless plating or by a vapor deposition method such as vacuum deposition or chemical vapor deposition (CVD).

The fuel cell system 800 further includes a gas-liquid separation membrane 815 placed between the fuel container 811 and the container 801. The gas-liquid separation membrane 815 is a hydrophobic film, for example, composed of polyether sulfone, an acrylic copolymer, or the like. Examples of the gas-liquid separation membranes 815 include Goatex (registered trademark), manufactured by Japan Goatex K.K., Versapore (registered trademark), manufactured by Nihon Pall Ltd., Supor (registered trademark), manufactured by Nihon Pall Ltd., and the like.

In the gas treatment unit 804, the container 801 is partitioned by the catalyst layer 805 to an upper chamber 801a and a lower chamber 801b. The lower chamber 801b has an inlet 809 introducing the untreated gas 802 discharged from the fuel container 811. The inlet 809 of the container 801 is connected to an opening 813 formed at the upper region of one end of the fuel container 811 that stores the fuel 124 supplied to the unit cell 101, via the gas-liquid separation membrane 815. An exhaust vent 807 for discharge of the treated gas 806 is formed at the upper end of the upper chamber 801a.

In addition, an oxygen inlet 817 supplying oxygen 816 is formed in the lower chamber 801b of the container 801, and the oxygen 816 is supplied from an oxygen-supplying unit not shown in the drawings. Although the oxygen 816 is supplied in the present embodiment, the present invention is not limited to the configuration of supplying oxygen. Thus, air containing oxygen or other gas may be supplied through the oxygen inlet 817. The configuration of supplying some gas through the oxygen inlet 817 can generate air flow in the container 801, leading to acceleration of the treatment of the untreated gas 802 discharged into the container 801 through the catalyst layer 805 and the discharge of the treated gas through the exhaust vent 807. A configuration of supplying oxygen by oxygen-supplying unit is described, but other configuration, for example of incorporating only external air without using the oxygen-supplying unit, may also be employed in the present invention.

Seal parts are placed respectively between the opening 813 of the fuel container 811 and the gas-liquid separation membrane 815, the gas-liquid separation membrane 815 and the inlet 809 of the container 801, the lower chamber 801b of the container 801 and the carbon paper supporting the catalyst layer 805, and the carbon paper and the upper chamber 801a of the container 801.

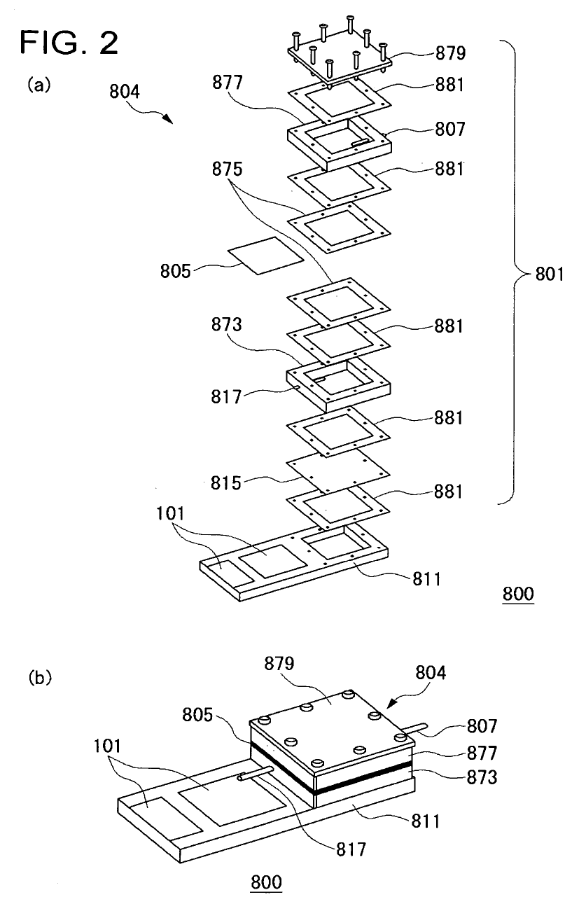

FIG. 2 includes an exploded view and an assembly drawing of the gas treatment unit 804 in the fuel cell system 800 described above. FIG. 2(a) is an exploded view of the gas treatment unit 804 in the fuel cell system 800, and FIG. 2(b) is an assembly drawing of the gas treatment unit 804 shown in FIG. 2(a). The gas treatment unit 804 may be connected to the fuel container 811 in a detachable manner.

In the fuel cell system 800 of the present embodiment, as shown in the exploded view of FIG. 2(a), the container 801 in the gas treatment unit 804 includes a gas-liquid separation membrane 815, a first container 873 having an oxygen inlet 817, a carbon paper supporting the catalyst layer 805, two frames 875 grasping the carbon paper supporting the catalyst layer 805 from both sides, a second container 877 having an exhaust vent 807, and a top plate 879. Seal parts 881 are placed respectively between them, for prevention of leakage of the fuel 124.

FIG. 2(b) is a drawing illustrating the gas treatment unit 804 of the fuel cell system 800 assembled in such a configuration, and the cross-sectional view is similar to that shown in FIG. 1. That is, an upper chamber 801a of the container (FIG. 1) is formed with the top plate 879, the second container 877 and the carbon paper supporting the catalyst layer 805, while an lower chamber 801b of the container (FIG. 1) is formed with the carbon paper supporting the catalyst layer 805, the first container 873 and the gas-liquid separation membrane 815.

Hereinafter, operation of the fuel cell system 800 in such a configuration will be described with reference to FIGS. 1 and 2.

Carbon dioxide is generated on the fuel electrode 102 in the electrochemical reaction caused by the unit cells 101. Part of the alcohol, such as methanol, contained in the unreacted fuel 124 vaporizes into gas. By-products such as formic acid (HCOOH), methyl formate (HCOOCH₃), and formaldehyde (HCOH) are also generated then. The gas including carbondioxide, alcohol, formicacid, methyl formate, and formaldehyde is discharged as the untreated gas 802 into the container 801 through the gas-liquid separation membrane 815. The untreated gas 802 collected in the container 801 is oxidized by the catalyst layer 805 in the reactions represented by the following Formulae (4) to (7).
CH₃OH+3/2O₂→CO₂+2H₂O (4)
HCOOH+1/2O₂→CO₂+H₂O (5)
HCOOCH₃+2O₂→2CO₂+2H₂O (6)
HCOH+O₂→CO₂+H₂O (7)

The unreacted fuel gas and the by-products contained in the untreated gas 802 are thus oxidized into carbon dioxide and water. The treated gas 806 after oxidation is then discharged externally through the exhaust vent 807. Supply of oxygen 816 through the oxygen inlet 817 at the time accelerates oxidation of the untreated gas 802 by the catalyst layer 805.

As described above, the fuel cell system 800 in the present embodiment, which has a configuration of discharging the gas from the fuel cell after it is oxidized, allows detoxification of the gas in a simple configuration, consequently reducing adverse effects on the environment and the human body and improving the maintainability and reliability of the fuel cell system.

### Second Embodiment

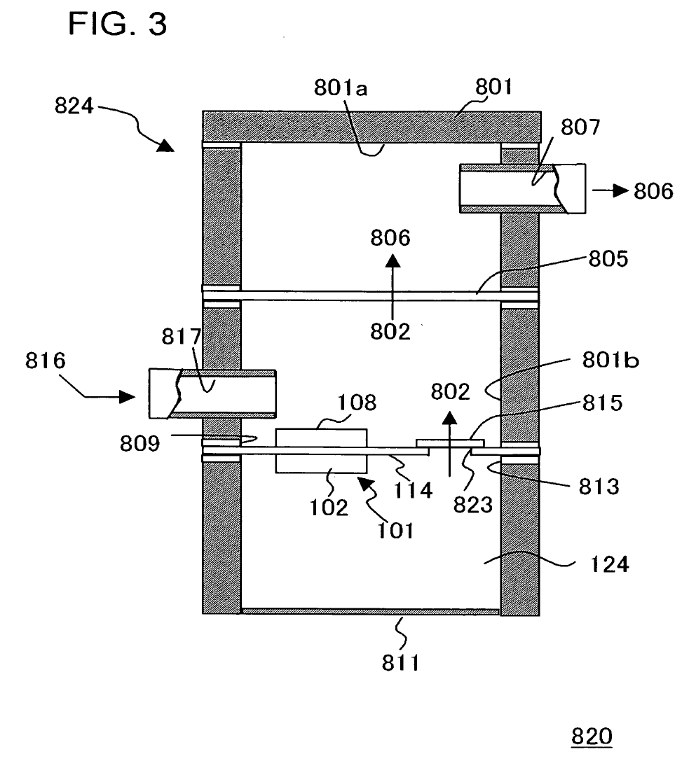

FIG. 3 is a schematic sectional view illustrating a structure of a fuel cell system in an embodiment of the present invention.

The fuel cell system 820 in the present embodiment is different from the fuel cell system 800 in the embodiment above, in that a gas treatment unit 824 is formed to each unit cell 101 of the fuel cell.

In the system, the gas treatment unit 824 is formed in the upper region of the unit cell 101. The unit cell 101 is placed close to an opening 813 of the fuel container 811, and a gas-liquid separation membrane 815 is placed over a hole 823 formed in the solid electrolyte membrane 114 of the unit cell 101. In such a configuration, it is not necessary to make a region for the gas treatment unit 824 available, separately from the region for the unit cell 101, and to make the fuel cell system compact and reduce the size of the entire system.

### Third Embodiment

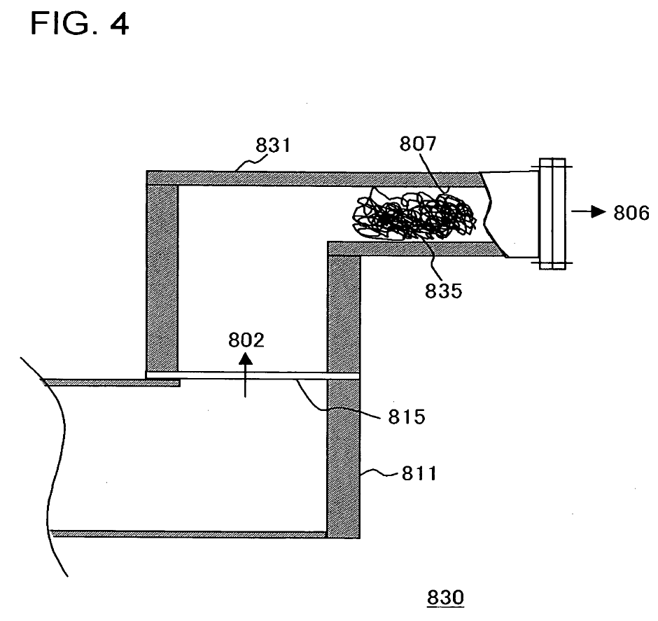

FIG. 4 is a schematic sectional view illustrating a structure of a fuel cell system in an embodiment of the present invention.

The fuel cell system 830 in the present embodiment is different from those in the first and second embodiments in its shape of the catalyst. The fuel cell system 830 contains a catalyst 835 in the shape of wire wool. The catalyst 835 is filled in the exhaust vent 807 placed at the top of an outlet passage 831.

In the present embodiment, the wire wool-shaped catalyst 835 may be made of a metal, an alloy, or the oxide thereof similar to that contained in the catalyst layer 805 described in the first embodiment.

Although not shown in the Figure, the outlet passage 831 may have a configuration having an oxygen inlet 817 for supplying the oxygen 816, similarly to those described with reference to FIGS. 1 and 3 in the first and second embodiments; and oxygen 816 may be supplied from an oxygen-supplying unit not shown in the Figure.

Thus, the shape of the catalyst 835 is not particularly limited, if the system has a configuration in which the untreated gas 802 discharged from the fuel container 811 maybe oxidized. For example, a wire made of the metal, alloy, or other oxide described above may be used as it is or as it is converted into the mesh form.

The system in the present embodiment also gives advantageous effects similar to those described in the first and second embodiments.

### Fourth Embodiment

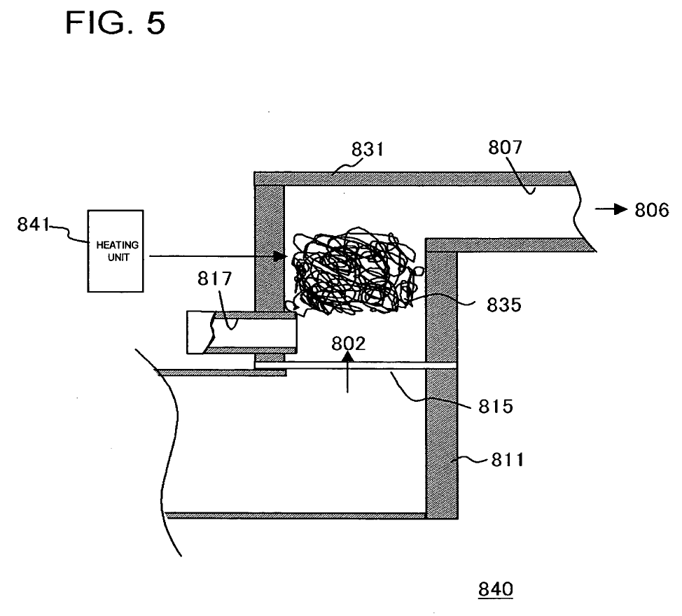

FIG. 5 is a schematic sectional view illustrating a structure of a fuel cell system in an embodiment of the present invention.

The fuel cell system 840 in the present embodiment is different from the systems in the first to third embodiments, in that it contains a heating unit 841. Although the fuel cell system 840 shown has a configuration containing a wire wool-shaped catalyst 835 similar to that described in the third embodiment, it may also have a configuration containing the catalyst layer 805 described in the first and second embodiments; and the shape of the catalyst is not particularly limited.

The heating unit 841 is, for example, a heater, and is preferably placed properly to heat the neighborhood of the catalyst 835 in the outlet passage 831. In this manner, it is possible to oxidize the untreated gas 802 deposited onto the catalyst 835 efficiently and reliably. Alternatively, the heating unit 841 may be a heating heater installed separately outside the periphery of the outlet passage 831, and thus, the system may have a configuration in which the untreated gas 802 in the outlet passage 831 is introduced into the heating unit 841 and fed back into the outlet passage 831 after heating. Yet alternatively, the system may have a configuration in which oxygen from the oxygen inlet 817 is supplied after it is heated. In this manner, it is possible to accelerate oxidation of the untreated gas 802 by the catalyst 835.

The treatment of the untreated gas 802 from the fuel container 811 in the heating unit 841 may be performed consistently or periodically at an interval, for example, after operation of the fuel cell system 840 for a particular period. Operation of the fuel cell system 840 for an extended period of time may result in deterioration of its oxidation efficiency because of deposition of unoxidized and liquefied components on the catalyst 835. In such a case, it is possible to reactivate the oxidation capacity of the catalyst 835 by removing the untreated gas 802 deposited on the catalyst 835 efficiently. In the fuel cell system 840, the untreated gas 802 discharged from the fuel container 811 contains almost no components other than the alcohol, formic acid, methyl formate, formaldehyde and the like described above. For that reason, the catalyst 835 is free from contamination with impurities; and it is possible to improve the durability of the catalyst 835 by removing the untreated gas 802 deposited on the catalyst 835 periodically by heat treatment.

In the fuel cell system 840 in such a configuration, it is possible to accelerate oxidation by the catalyst 835, oxidize and remove completely the untreated gas 802 more efficiently and reliably, and retain the performance of the catalyst 835, by heating the untreated gas 802 discharged from the fuel container 811 in the heating unit 841. In this manner, it is possible to improve the maintainability and reliability of the fuel cell system 840.

In the embodiments above, the oxygen supply unit and the heating unit are described as the oxidation-accelerating unit which accelerates catalytic oxidation of the exhaust gas impurities, but the oxidation-accelerating unit are not limited thereto, and, for example, application of a pressure unit, vibration unit, agitation unit, or the like may also be used as another oxidation-accelerating units.

Yet in another embodiment, the catalyst may be a photocatalyst, and in such a case, the oxidation-accelerating unit may be an irradiation of light. Examples of the photocatalysts include semiconductors such as titanium dioxide, and organometallic complexes, and, for example, platinum supporting fine particles of titanium dioxide may be used.

### Fifth Embodiment

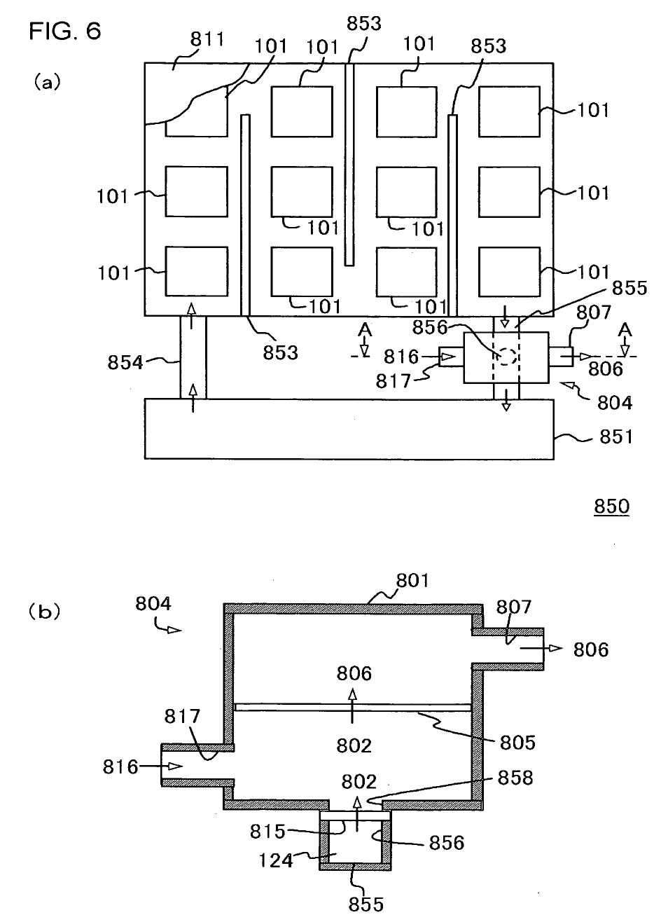

FIG. 6 include schematic partial cross-sectional horizontal views and vertical sectional views illustrating a structure of a fuel cell system in an embodiment of the present invention. FIG. 6(a) is a schematic partial cross-sectional plan view illustrating the configuration of the fuel cell system in the present embodiment, and FIG. 6(b) is a sectional view thereof along the line A-A in FIG. 6(a).

The fuel cell system 850 includes a plurality of unit cells 101 of a fuel cell, a fuel container 811 containing the multiple unit cells 101, and a fuel tank 851 supplying a fuel 124 into the fuel container 811 and recovering the fuel 124 circulated through the fuel container 811. The fuel container 811 and the fuel tank 851 are connected to each other via fuel passages 854 and 855. A gas treatment unit 804 is placed on the fuel passage 855.

In the present embodiment, the fuel 124 is supplied to the fuel container 811 through the fuel passage 854. The fuel 124 flows along multiple partitioning plates 853 installed in the fuel container 811, and is supplied to the multiple unit cells 101 sequentially. The fuel 124 circulated through the multiple unit cells 101 is then recovered through the fuel passage 855 into the fuel tank 851.

The fuel tank 851 may be a cartridge detachable from the main body of the fuel cell system 850 including the fuel container 811.

In the fuel cell system 850 of the present embodiment, an inlet 858 of the container 801 is connected to an opening 856 of the fuel passage 855 via a gas-liquid separation membrane 815, and the untreated gas 802 is supplied from the fuel passage 855 into the container 801 through the gas-liquid separation membrane 815. The container 801 may be made detachable from the fuel passage 855.

The untreated gas 802 collected in the container 801 is oxidized and detoxified by the catalyst layer 805 in a similar manner to the first embodiment and then discharged into the air through the exhaust vent 807 of the container 801.

A configuration having only one gas treatment unit 804 installed on the fuel passage 855 is described in the present embodiment, but as described in the second embodiment, it is possible to have a configuration in which multiple gas treatment units 804 are placed respectively at the top of the multiple unit cells 101.

### Sixth Embodiment

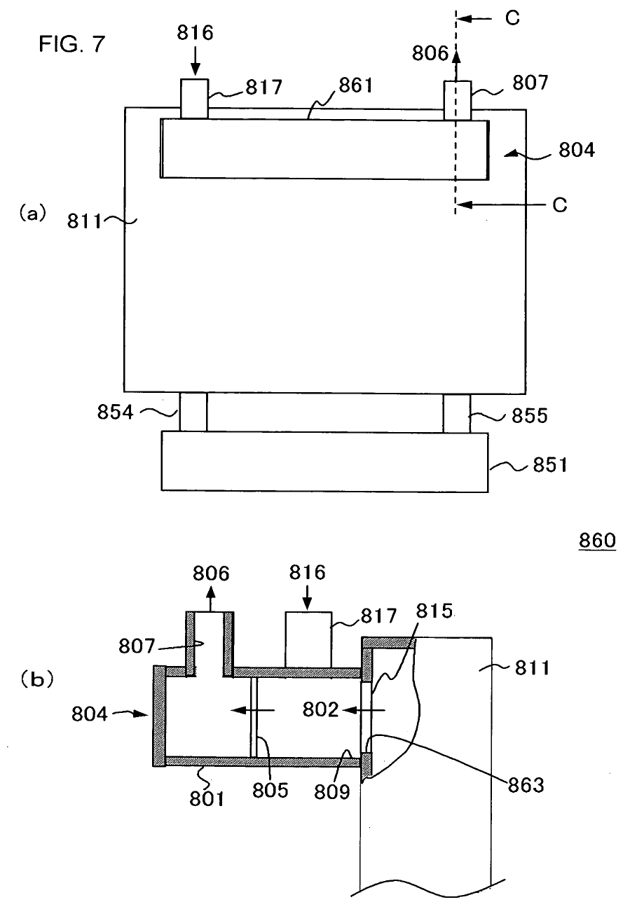

FIG. 7 include schematic plan view and partial sectional view illustrating a structure of a fuel cell system in an embodiment of the present invention. FIG. 7(a) is a schematic plan view illustrating the configuration of the fuel cell system in the present embodiment, and FIG. 7(b) is a partial sectional view thereof along the line C-C in FIG. 7(a).

The fuel cell system 860 in the present embodiment is different from that in the fifth embodiment, in that a gas treatment unit 804 is placed at an end position of the upper region of the fuel tank 851.

In the fuel cell system 860, an inlet 809 of the container 801 is connected to an opening 863 formed at an end position of the upper region of the fuel container 811, via a gas-liquid separation membrane 815. The untreated gas 802 in the fuel container 811 flows into the container 801 through the gas-liquid separation membrane 815. The container 801 may be made detachable from the fuel container 811.

In the fuel cell system 860 in the present embodiment having such a configuration, the untreated gas 802 collected in the container 801 is oxidized and detoxified by the catalyst layer 805 in a similar manner to the first embodiment and discharged into the air through the exhaust vent 807 of the container 801.

### EXAMPLE

A fuel cell system 800 in the configuration shown in FIG. 1 was prepared, and the concentration of methanol in the gas discharged from the exhaust vent 807 was determined by gas chromatography. In this configuration, the concentration of methanol was determined both when the temperature inside the container 801 was 25° C. (room temperature) and 40° C. (high temperature) and both when oxygen was supplied and not supplied through the oxygen inlet 817. The methanol concentration when no catalyst layer 805 was formed in the container 801 (temperature inside the container 801: 25° C.) was also determined for reference example. Results are summarized in Table 1.

TABLE 1

| | WITH CATALYST | | | |
|---|---|---|---|---|
| | ROOM TEMPERATURE (25° C.) | | HIGH TEMPERATURE (40° C.) | |
| WITHOUT | WITHOUT | WITH | WITHOUT | WITH |
| CATALYST | OXYGEN SUPPLY | OXYGEN SUPPLY | OXYGEN SUPPLY | OXYGEN SUPPLY |
| (μg/mL) | (μg/mL) | (μg/mL) | (μg/mL) | (μg/mL) |
| 13.15 | 8.85 | 4.24 | 6.46 | 3.03 |
| 9.53 | 9.15 | 4.95 | 7.24 | 2.62 |
| 10.61 | 8.3 | 3.89 | 7.21 | 2.08 |
| 11.02 | 9.08 | 4.57 | 6.88 | 2.17 |

As shown in Table 1, presence of the catalyst layer 805 in the container 801 resulted in reduction in the concentration of methanol in the gas discharged from the exhaust vent 807, compared to the case when no catalyst layer 805 was formed. It seems that methanol was oxidized and removed by the catalyst in the catalyst layer 805. As shown in Table 1, it was also possible to reduce the concentration of methanol further, by raising the temperature inside the container 801 from 25° C. to 40° C. It was also possible to reduce the concentration of methanol in the gas discharged from the exhaust vent 807, by supplying oxygen into the container 801 both when the temperatures inside the container 801 were 25° C. and 40° C.

1. A fuel cell system, comprising:
a fuel cell including a solid polymer electrolyte membrane and a fuel electrode and an oxidant electrode placed on said solid polymer electrolyte membrane;
a container storing a fuel placed in contact with said fuel electrode;
an outlet passage discharging the gas contained in said container into the air; and
a catalyst placed in said outlet passage that oxidizes said gas.

2. The fuel cell system as set forth in claim 1, further comprising an oxidation-accelerating unit accelerating oxidation of said gas by said catalyst.

3. The fuel cell system as set forth in claim 2,
wherein said oxidation-accelerating unit has an oxygen-supplying unit supplying oxygen to said gas.

4. The fuel cell system as set forth in claim 2,
wherein said oxidation-accelerating unit has a heating unit heating said gas or said catalyst.

5. The fuel cell system as set forth in claim 1, comprising a plurality of fuel cells,
wherein said container is formed in contact with each of said fuel electrodes of said plurality of fuel cells.

6. The fuel cell system as set forth in claim 1, further comprising a recovering passage recovering the fuel supplied to said fuel electrode,
wherein said outlet passage is configured to discharge the gas contained in the fuel passing through said recovering passage into the air.

7. The fuel cell system as set forth in claim 1, further comprising a gas-liquid separation membrane placed between said container and said outlet passage,
wherein said catalyst is configured to oxidize said gas discharged through said gas-liquid separation membrane into said outlet passage.

8. The fuel cell system as set forth in claim 1,
wherein said fuel cell is a direct type fuel cell in which a liquid fuel is supplied to said fuel electrode.

9. A gas treatment apparatus, detachably connected to a fuel cell including a unit cell having a solid polymer electrolyte membrane, and a pair of fuel electrode and oxidant electrode placed on said solid polymer electrolyte membrane and a container storing a fuel placed in contact with said fuel electrode, comprising:
a housing having an inlet introducing gas contained in said container and an exhaust vent discharging said gas into the air; and
a catalyst which is placed in said housing and oxidizes said gas taken in said housing;
wherein said catalyst is placed so as to oxidize said gas introduced through the inlet of said housing and then discharge said gas after oxidation through said exhaust vent.

10. The gas treatment apparatus as set forth in claim 9, further comprising an oxidation-accelerating unit accelerating oxidation of said gas by said catalyst.

11. The gas treatment apparatus as set forth in claim 10,
wherein said oxidation-accelerating unit has an oxygen-supplying unit supplying oxygen to said gas.

12. The gas treatment apparatus as set forth in claim 10,
wherein said oxidation-accelerating unit has a heating unit heating said gas or said catalyst.

13. A method of operating a fuel cell, comprising:
oxidizing gas discharged from a fuel cell including a solid polymer electrolyte membrane, and a pair of fuel electrode and oxidant electrode placed on said solid polymer electrolyte membrane with a catalyst; and then,
discharging the oxidized gas into the air.

14. The method of operating the fuel cell as set forth in claim 13,
wherein said fuel cell is a direct type fuel cell driven by supplying a liquid fuel to said fuel electrode,
wherein said fuel cell further includes a container that is placed in contact with said fuel electrode and stores said liquid fuel and
wherein said gas is discharged from said fuel container.

15. The method of operating the fuel cell as set forth in claim 13, further comprising accelerating oxidation by said catalyst.

16. The method of operating the fuel cell as set forth in claim 15,
wherein said accelerating oxidation includes supplying oxygen to said gas.

17. The method of operating the fuel cell as set forth in claim 15,
wherein said accelerating oxidation includes heating said gas or said catalyst.
